(19) United States
(12) Patent Application Publication
(10) Pub. No.: US 2026/0320841 A1
(43) Pub. Date: Oct. 15, 2026

(54) REDNESS DIFFERENTIATION CALIBRATION (R.D.C.) METHOD FOR MEDICAL IMAGES

(71) Applicant: Weyo Surgical Technology Ltd., Jiangsu (CN)

(72) Inventors: Zhiqiang Ren, Jiangsu (CN); Peng Zou, Jiangsu (CN); Shengbo Li, Jiangsu (CN)

(73) Assignee: Weyo Surgical Technology Ltd., Jiangsu (CN)

(21) Appl. No.: 19/485,657

(22) PCT Filed: Mar. 19, 2025
(86) PCT No.: PCT/CN2025/083298

§ 371 Date: Nov. 18, 2025

(30) Foreign Application Priority Data
Jun. 17, 2024 (CN) 202410775242.1

(51) Int. Cl. G06T 7/90; G06T 5/73; G06T 7/00

(52) U.S. Cl. CPC G06T 7/90; G06T 5/73; G06T 7/0012; G06T 2207/10024; G06T 2207/10068

(57) ABSTRACT

The present invention relates to the technical field of image processing, and in particular to a redness differentiation calibration (R.D.C.) method for medical images. The method includes the following steps: acquiring an original image to obtain L, a, and b values of the original image, performing redness intensity estimation on the original image using the a and b values, performing edge information extraction on the original image using the L value, performing calibration on the original image by calculation to obtain a calibration result L_{Q}, and converting the original image from a CIELAB color space to an RGB color space using the obtained L_{Q}, a, and b values, and outputting a resulting image.

### TECHNICAL FIELD

The present invention relates to the technical field of image processing, and in particular to a redness differentiation calibration (R.D.C.) method for medical images.

### RELATED ART

Modern endoscopes play a crucial role in various scenarios such as gastrointestinal disease diagnosis and laparoscopic surgery. High endoscopic image quality helps improve the level of diagnosis.

Currently, due to unclear spectral discrimination in red wavelength bands regarding the reflectance spectra of mucosa, blood vessels, and tissues, endoscopic imaging systems demonstrate inadequate red color gradation during critical procedures such as examinations and surgery, thereby causing inconvenience for doctors during treatment and judgment.

### SUMMARY OF INVENTION

In order to overcome the above technical problems, an objective of the present invention is to provide a redness differentiation calibration (R.D.C.) method for medical images to improve the red color gradation displayed by the endoscope in critical procedures such as examinations and surgery.

The objective of the present invention may be achieved by the following technical solution.

A redness differentiation calibration (R.D.C.) method for medical images comprises the following steps:
S1: acquiring an original image and converting the original image from an RGB color space to a CIELAB color space to obtain L, a, and b values of the original image;
S2: performing redness intensity estimation on the original image using the a and b values obtained in step S1;
S3: performing edge information extraction on the original image using the L value obtained in step S1;
S4: performing calibration on the original image by calculation using the L value, a redness intensity result and an edge information result obtained in step S1, step S2 and step S3, to obtain a calibration result L_{Q}; and
S5: converting the original image from the CIELAB color space to the RGB color space using the obtained L_{Q}, a, and b values, and outputting a resulting image.

Further, in step S1, the original image to be processed includes at least 8-bit and 10-bit images in terms of color depth.

Further, in step S1, a specific method for calculating the L, a, and b values comprises:
S11: converting an RGB range of the original image to between 0 and 1 to obtain target R, G, and B values; and
S12: converting the obtained target R, G, and B values to X, Y, and Z values using the following formula, and then converting the X, Y, and Z values to three L, a, and b channel component values in the CIELAB color space, wherein the three L, a, and b channel component values range from 0 to 255:

$$[ \begin{matrix}X \\ Y \\ Z\end{matrix} ] = [ \begin{matrix}0.41 & 0.36 & 0.18 \\ 0.21 & 0.72 & 0.07 \\ 0.02 & 0.12 & 0.95\end{matrix} ] \cdot [ \begin{matrix}R \\ G \\ B\end{matrix} ] , \qquad \# ( 1 )$$

the X, Y, and Z values are obtained;

$${L}^{*} = \{ \begin{matrix}116 * {Y}^{\frac{1}{3}} - 16 , & for Y > 0.008856 \\ 903.3 * Y , & for Y \leq 0.008856\end{matrix} ; \qquad \# ( 2 )$$

$$L = {L}^{*} * \frac{255}{100} ; \qquad \# ( 3 )$$

$$a = 50 \; 0 ( f ( X ) - f ( Y ) ) + 256 ; \qquad \# ( 4 )$$

$$b = 20 \; 0 ( f ( Y ) - f ( Z ) ) + 256 ; \qquad \# ( 5 )$$

in formulas (4) and (5):

$$f ( t ) = \{ \begin{matrix}{t}^{\frac{1}{3}} , & for t > 0.008856 \\ 7.787 t + 16 / 116 , & for t \leq 0.008856\end{matrix} ; \qquad \# ( 6 )$$

finally, the three L, a, and b channel component values are obtained.

Further, after the X, Y, and Z values are obtained through formula (1), the obtained X, Y, Z values are normalized according to X, Y, and Z values specified by a reference white point D65:
a value obtained after

$$X being normalized = \frac{X}{{X}_{n}} , \qquad \# ( 7 )$$

wherein Xₙ=0.950456;
a value obtained after

$$Y being normalized = \frac{Y}{{Y}_{n}} , \qquad \# ( 8 )$$

wherein Yₙ=1;
a value obtained after

$$Z being normalized = \frac{Z}{{Z}_{n}} , \qquad \# ( 9 )$$

wherein Zₙ=0.950456;

Further, in step S2, a specific method for performing redness intensity estimation on the original image comprises:
S21: performing the following calculations using the obtained a and b values:

$$weight A = \frac{abs ( a - 128 )}{127} ; \qquad \# ( 10 )$$

$$weight B = \frac{127 - abs ( b - 128 )}{127} ; \qquad \# ( 11 )$$

redness=(weightA*weightB)^{γ}# (12);
wherein abs( ) represents taking the absolute value, and y is a weight adjustment coefficient; and
S22: normalizing the obtained result to obtain an estimated redness intensity:

$$weight = \frac{redness}{max ( redness )} ; \qquad \# ( 13 )$$

wherein max( ) represents taking the maximum value.

Further, in step S3, a specific method for performing edge information extraction on the original image is: edge=L−L_{blur} #(14);
wherein L_{blur} represents a blurred image of an L channel.

Further, the blurred image of the L channel is achieved by using a 9*9 Gaussian filter.

Further, in step S4, a specific method for performing calibration on the original image by calculation comprises:
S41: first, performing transformation on the L channel using a nonlinear mapping function as follows:

$$f ( L ) = \frac{{L}^{f} * {g}^{h}}{{g}^{h} * {L}^{f} + {( l - L )}^{h} * {e}^{f}} ; \qquad \# ( 15 )$$

wherein e, f, g, and h are adjustment parameters of the nonlinear mapping function to adjust an inflection point and a level of stretch of a mapping curve;
S42: adjusting an intensity of image calibration using the following formula:

DeltaL=(f(L)−L)*coeffL+edge*coeffE # (16);
wherein coeffL=5, coeffE=4.5; and
S43: obtaining the calibration result L_{Q} using the following formula, wherein L_{Q} ranges from 0 to 25;

L_{Q}=L+DeltaL*weight # (17).

Further, e=5, f=1.7, g=8, and h=1.4.

Further, in step S5, during the conversion, the X, Y, and Z values to be converted are first obtained through the following formulas:

X=0.950456*xᵣ# (18);

Y=yᵣ# (19);

Z=1.088754*zᵣ# (20);
wherein

$${x}_{r} = \{ \begin{matrix}{f}_{x}^{3} , & for {f}_{x} > 0.008 \; 856 \\ ( 116 {f}_{x} - 16 ) / 903.3 , & for {f}_{x} \leq 0 \text{.008856}\end{matrix} ; \qquad \# ( 21 )$$

$${z}_{r} = \{ \begin{matrix}{f}_{z}^{3} , & for {f}_{z} > 0.008 \; 856 \\ ( 116 {f}_{z} - 16 ) / 903.3 , & for {f}_{z} \leq 0.0 \; 08856\end{matrix} ; \qquad \# ( 22 )$$

$${y}_{r} = \{ \begin{matrix}{( \frac{{L}_{Q} + 16}{116} )}^{3} , & for {L}_{Q} > 8 \\ \frac{116 {f}_{x} - 16}{903.3} , & for {L}_{Q} \leq 8\end{matrix} ; \qquad \# ( 23 )$$

$${f}_{x} = \frac{a}{500} + {f}_{y} ; \qquad \# ( 24 )$$

$${f}_{y} = \frac{{L}_{Q} + 16}{116} ; \qquad \# ( 25 )$$

$${f}_{z} = {f}_{y} - \frac{b}{200} ; \qquad \# ( 26 )$$

then, the obtained X, Y, and Z values to be converted are filled into the following formula to obtain r, g, and b values:

$$[ \begin{matrix}r \\ g \\ b\end{matrix} ] = {[ \begin{matrix}0.41 & 0.36 & 0.18 \\ 0.21 & 0.72 & 0.07 \\ 0.02 & 0.12 & 0.95\end{matrix} ]}^{- 1} \cdot [ \begin{matrix}X \\ Y \\ Z\end{matrix} ] ; \qquad \# ( 27 )$$

and finally, the r, g, and b values are restored to the R, G, and B range of the original image and the resulting image is output.

The present invention has the following advantageous effects:

Compared with conventional methods, according to the present technical solution, an original image is converted from an RGB color space to a CIELAB color space to obtain L, a, and b values of the original image; then, redness intensity estimation and edge information extraction are performed on the original image in turn, and calibration is performed on the original image by calculation to obtain a calibration result L_{Q}; and finally, the original image is converted from the CIELAB color space to the RGB color space, and a resulting image is output. Results show that according to this method, the contrasts and edges of red regions are calibrated by estimating the redness intensity of each pixel in the original image, so that the color differentiation and clarity of key parts are improved, and the display of blood vessels and structures of the surface mucosa is strengthened. Therefore, the method is of great significance in the discovery and diagnosis of tiny lesions, targeted biopsy, localization of lesion boundaries, and tissue localization during surgery, etc.

### BRIEF DESCRIPTION OF DRAWINGS

The present invention is further described below with reference to the accompanying drawings.

FIG. 1 is a schematic diagram of a processing flow of a redness differentiation calibration (R.D.C.) method for medical images according to the present invention;

FIG. 2 is an example of an image from an original endoscope;

FIG. 3 is an output image obtained after the image in FIG. 2 is subjected to redness intensity estimation;

FIG. 4 is an output image obtained after the image in FIG. 3 is subjected to edge information extraction;

FIG. 5 is an output image obtained after the image in FIG. 4 is calibrated by calculation; and

FIG. 6 is an output image obtained after the image in FIG. 5 is subjected to LAB color space conversion.

### DESCRIPTION OF EMBODIMENTS

The technical solutions in the embodiments of the present invention are clearly and fully described below in conjunction with the embodiments of the present invention. Apparently, the embodiments described are merely some, rather than all embodiments of the present invention. All other embodiments, obtained by persons of ordinary skill in the art based on the embodiments of the present invention without creative efforts, shall fall within the scope of protection of the present invention.

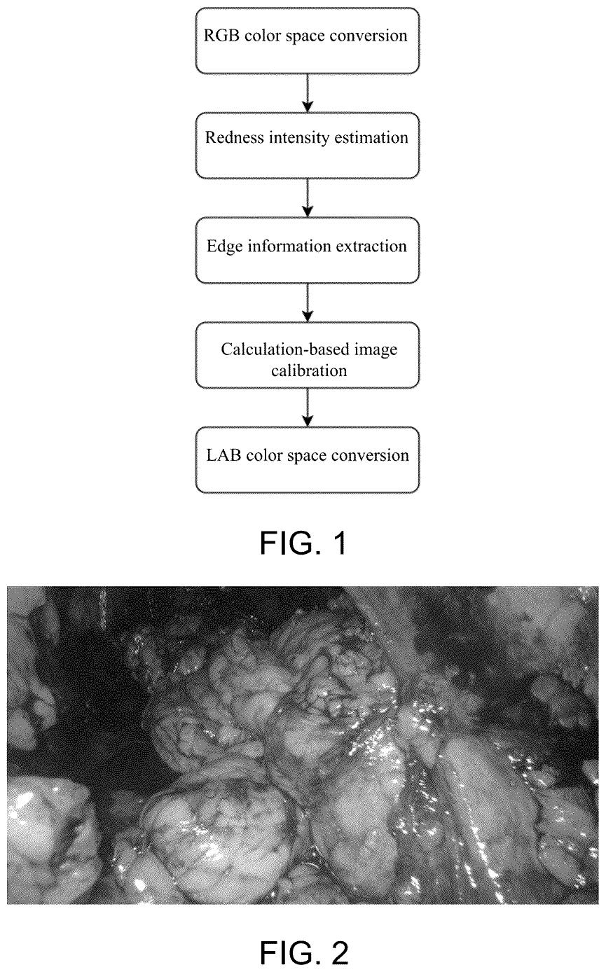

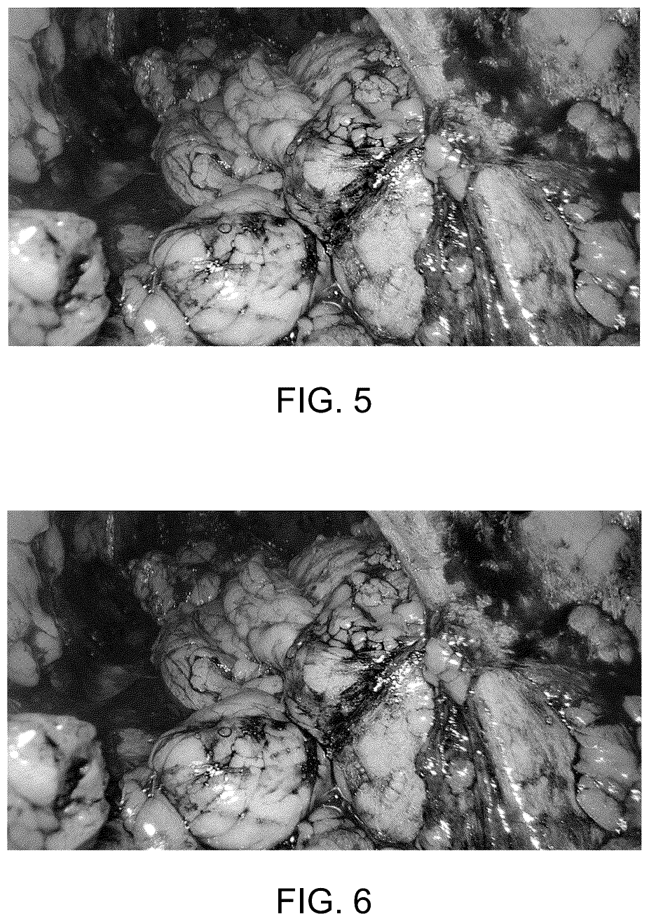

As shown in FIGS. 1, 2, 3, 4, 5, and 6, a redness differentiation calibration (R.D.C.) method for medical images includes the following steps:
S1: An original image is acquired, and the original image is converted from an RGB color space to a CIELAB color space to obtain L, a, and b values of the original image, where CIELAB is a device-independent color space that includes three channels: brightness L, a range a from red to green, and a range b from yellow to blue, so that it can better describe the perceptual properties of color; and by converting the RGB color space to the CIELAB color space, the color information of the image can be more accurately represented and processed, which is beneficial for color-related image processing tasks such as color correction, color matching, image segmentation.

The original image being processed by the method includes at least 8-bit and 10-bit images in terms of color depth.
S11: When the original image being processed is an 8-bit image, an RGB range of the original image needs to be converted to between 0 and 1. This can be achieved by dividing R, G, and B values to be input in the original image by 255. Finally, target R, G, and B values will be obtained; and
S12: the obtained target R, G, and B values is converted to X, Y, and Z values using the following formula, and then the X, Y, and Z values are converted to three L, a, and b channel component values in the CIELAB color space, where the three L, a, and b channel component values range from 0 to 255:

$$[ \begin{matrix}X \\ Y \\ Z\end{matrix} ] = [ \begin{matrix}0.41 & 0.36 & 0.18 \\ 0.21 & 0.72 & 0.07 \\ 0.02 & 0.12 & 0.95\end{matrix} ] \cdot [ \begin{matrix}R \\ G \\ B\end{matrix} ] , \qquad \# ( 1 )$$

after the X, Y, and Z values are obtained through formula (1), the obtained X, Y, Z values are normalized according to X, Y, and Z values specified by a reference white point D65:
a value obtained after

$$X being normalized = \frac{X}{{X}_{n}} , \qquad \# ( 7 )$$

wherein Xₙ=0.950456;
a value obtained after

$$Y being normalized = \frac{Y}{{Y}_{n}} , \qquad \# ( 8 )$$

wherein Yₙ=1;
a value obtained after

$$Z being normalized = \frac{Z}{{Z}_{n}} , \qquad \# ( 9 )$$

wherein Zₙ=0.950456.

The normalized X, Y, and Z values are obtained according to formulas (7), (8) and (9), and three L, a, and b channel component values can be obtained using the following formulas:

$${L}^{*} = \{ \begin{matrix}116 * {Y}^{\frac{1}{3}} - 16 , & for Y > 0.008856 \\ 903.3 * Y , & for Y \leq 0.008856\end{matrix} ; \qquad \# ( 2 )$$

$$L = {L}^{*} * \frac{255}{100} ; \qquad \# ( 3 )$$

a=500(f(X)−f(Y))+256# (4);

b=200(f(Y)−f(Z))+256# (5);
in formulas (4) and (5):

$$f ( t ) = \{ \begin{matrix}{t}^{\frac{1}{3}} , & for t > 0.008856 \\ 7.787 t + 16 / 116 , & for t \leq 0.008856\end{matrix} ; \qquad \# ( 6 )$$

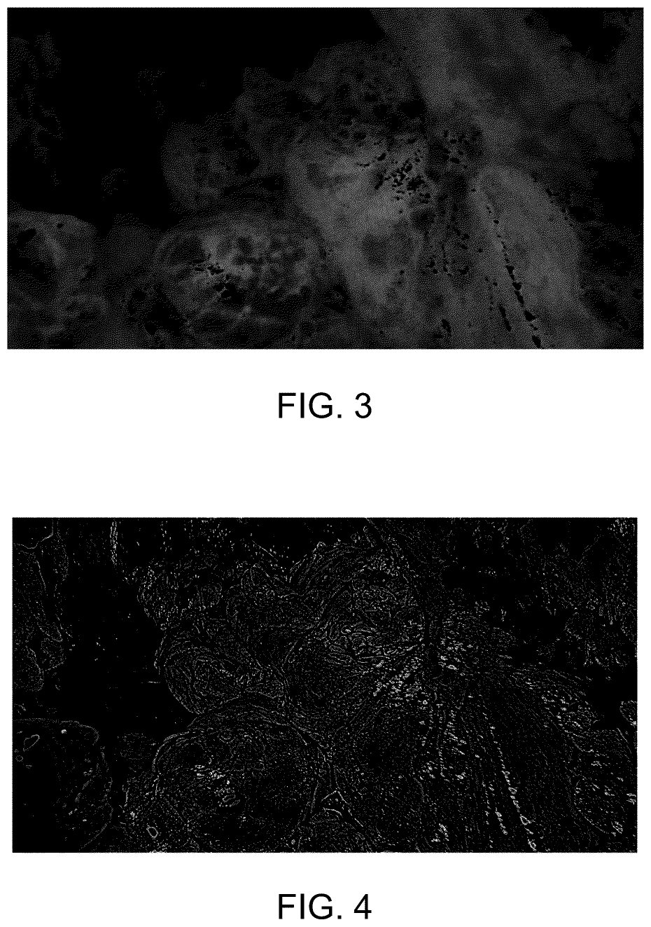

finally, the three L, a, and b channel component values are obtained;
S2: As shown in FIGS. 2 and 3, redness intensity estimation is performed on the original image using the a and b values obtained in step S1. A specific method includes:
S21: the following calculations are performed using the obtained a and b values:

$$weight A = \frac{abs ( a - 128 )}{127} ; \qquad \# ( 10 )$$

$$weight B = \frac{127 - abs ( b - 128 )}{127} ; \qquad \# ( 11 )$$

redness=(weightA*weightB)^{γ}# (12);
where abs( ) represents taking the absolute value, γ is a weight adjustment coefficient, and in the present embodiment, γ is 2; and
S22: the obtained result is normalized to obtain an estimated redness intensity:

$$weight = \frac{redness}{max ( redness )} ; \qquad \# ( 13 )$$

where max( ) represents taking the maximum value.
S3: As shown in FIG. 2 and FIG. 4, edge information extraction is performed on the original image using the L value obtained in step S1.

A common edge information extraction method is to subtract a blurred image from an original grayscale image to obtain a high-frequency component in the grayscale image. However, in this method, it is to subtract a blurred image of the L channel from the obtained L channel component value, that is: edge=L−L_{blur} #(14);
where L_{blur} represents the blurred image of the L channel. A blurring method of the blurred image of the L channel is not limited. In the present embodiment, the blurred image of the L channel is achieved by using a 9*9 Gaussian filter.
S4: As shown in FIGS. 2, 3, 4, and 5, calibration is performed on the original image by calculation using the L value, a redness intensity result and an edge information result obtained in step S1, step S2 and step S3, to obtain a calibration result L_{Q}. Through the calibration, the quality of the image can be improved, the specific features of the image can be calibrated, or the visualization effect of the image can be improved, thereby making the image clearer, easier to analyze, and more contrastive. A specific method of calculation includes:
S41: first, the L channel is transformed using a nonlinear mapping function as follows:

$$f ( L ) = \frac{{L}^{f} * {g}^{h}}{{g}^{h} * {L}^{f} + {( l - L )}^{h} * {e}^{f}} ; \qquad \# ( 15 )$$

where e, f, g, and h are adjustment parameters of the nonlinear mapping function, which can adjust an inflection point and a level of stretch of a mapping curve. In the present embodiment, e=5, f=1.7, g=8, and h=1.4;
S42: an intensity of image calibration is adjusted using the following formula:

DeltaL=(f(L)−L)*coeffL+edge*coeffE# (16);
where coeffL=5, coeffE=4.5; and
S43: the calibration result L_{Q} is obtained using the following formula, wherein L_{Q} ranges from 0 to 25;

L_{Q}=L+DeltaL*weight # (17).
S5: As shown in FIG. 6, the original image is converted from the CIELAB color space to the RGB color space using the obtained L_{Q}, a, and b values, and a resulting image is output:
during the conversion, the X, Y, and Z values to be converted are first obtained through the following formulas:

X=0.950456*xᵣ# (18);

Y=yᵣ# (19);

Z=1.088754*zᵣ# (20);
wherein

$${x}_{r} = \{ \begin{matrix}{f}_{x}^{3} , & for {f}_{x} > 0.008 \; 856 \\ ( 116 {f}_{x} - 16 ) / 903.3 , & for {f}_{x} \leq 0 \text{.008856}\end{matrix} ; \qquad \# ( 21 )$$

$${z}_{r} = \{ \begin{matrix}{f}_{z}^{3} , & for {f}_{z} > 0.008 \; 856 \\ ( 116 {f}_{z} - 16 ) / 903.3 , & for {f}_{z} \leq 0.0 \; 08856\end{matrix} ; \qquad \# ( 22 )$$

$${y}_{r} = \{ \begin{matrix}{( \frac{{L}_{Q} + 16}{116} )}^{3} , & for {L}_{Q} > 8 \\ \frac{116 {f}_{x} - 16}{903.3} , & for {L}_{Q} \leq 8\end{matrix} ; \qquad \# ( 23 )$$

$${f}_{x} = \frac{a}{500} + {f}_{y} ; \qquad \# ( 24 )$$

$${f}_{y} = \frac{{L}_{Q} + 16}{116} ; \qquad \# ( 25 )$$

$${f}_{z} = {f}_{y} - \frac{b}{200} ; \qquad \# ( 26 )$$

then, the obtained X, Y, and Z values to be converted are filled into the following formula to obtain r, g, and b values:

$$[ \begin{matrix}r \\ g \\ b\end{matrix} ] = {[ \begin{matrix}0.41 & 0.36 & 0.18 \\ 0.21 & 0.72 & 0.07 \\ 0.02 & 0.12 & 0.95\end{matrix} ]}^{- 1} \cdot [ \begin{matrix}X \\ Y \\ Z\end{matrix} ] ; \qquad \# ( 27 )$$

and finally, the r, g, and b values are restored to the R, G, and B range of the original image and the resulting image is output.

According to the solution, an original image is converted from an RGB color space to a CIELAB color space to obtain L, a, and b values of the original image; then, redness intensity estimation and edge information extraction are performed on the original image in turn, and calibration is performed on the original image by calculation to obtain a calibration result L_{Q}; and finally, the original image is converted from the CIELAB color space to the RGB color space, and a resulting image is output. Results show that the method can effectively estimate the redness intensity, calibrate mucosal structures and tissue features, and highlight microvessels in the superficial mucosa and submucosa of endoscopic images, while introducing minimal alterations to non-red regions, thus making processed images more suitable for doctors to make observation and make diagnoses.

In the description of the specification, reference to terms such as “one embodiment”, “example”, “specific example” means that the specific features, structures, materials or characteristics described in conjunction with the embodiments or examples are included in at least one embodiment or example of the present invention. In this specification, schematic expressions of the above terms do not necessarily refer to the same embodiment or example. Furthermore, the described specific features, structures, materials, or characteristics may be combined in any one or more embodiments or examples in any suitable manner.

The above contents are merely examples and explanations of the present invention. Those skilled in the art can make various modifications, additions or similar substitutions to the described specific embodiments, which shall all fall within the scope of protection of the present invention as long as they do not deviate from the invention or exceed the scope defined by the claims.

1. A redness differentiation calibration (R.D.C.) method for medical images, characterized by comprising following steps:
S1: acquiring an original image and converting the original image from an RGB color space to a CIELAB color space to obtain L, a, and b values of the original image;
in step S1, a specific method for calculating the L, a, and b values comprises:
S11: converting an RGB range of the original image to between 0 and 1 to obtain target R, G, and B values; and
S12: converting the obtained target R, G, and B values to X, Y, and Z values using following formula, and then converting the X, Y, and Z values to three L, a, and b channel component values in the CIELAB color space, wherein the three L, a, and b channel component values range from 0 to 255:
$$[ \begin{matrix}X \\ Y \\ Z\end{matrix} ] = [ \begin{matrix}0.41 & 0.36 & 0.18 \\ 0.21 & 0.72 & 0.07 \\ 0.02 & 0.12 & 0.95\end{matrix} ] \cdot [ \begin{matrix}R \\ G \\ B\end{matrix} ] , \qquad \# ( 1 )$$
the X, Y, and Z values are obtained;
$${L}^{*} = \{ \begin{matrix}116 * {Y}^{\frac{1}{3}} - 16 , & for Y > 0.008856 \\ 903.3 * Y , & for Y \leq 0.008856\end{matrix} ; \qquad \# ( 2 )$$
$$L = {L}^{*} * \frac{255}{100} ; \qquad \# ( 3 )$$
$$a = 50 \; 0 ( f ( X ) - f ( Y ) ) + 256 ; \qquad \# ( 4 )$$
$$b = 20 \; 0 ( f ( Y ) - f ( Z ) ) + 256 ; \qquad \# ( 5 )$$
in formulas (4) and (5):
$$f ( t ) = \{ \begin{matrix}{t}^{\frac{1}{3}} , & for t > 0.008856 \\ 7.787 t + 16 / 116 , & for t \leq 0.008856\end{matrix} ; \qquad \# ( 6 )$$
finally, the three L, a, and b channel component values are obtained;
after the X, Y, and Z values are obtained through formula (1), the obtained X, Y, Z values are normalized according to X, Y, and Z values specified by a reference white point D65:
a value obtained after
$$X being normalized = \frac{X}{{X}_{n}} , \qquad \# ( 7 )$$
wherein Xₙ=0.950456; a value obtained after
$$Y being normalized = \frac{Y}{{Y}_{n}} , \qquad \# ( 8 )$$
wherein Yₙ=1; and a value obtained after
$$Z being normalized = \frac{Z}{{Z}_{n}} , \qquad \# ( 9 )$$
wherein Zₙ=0.950456;
S2: performing redness intensity estimation on the original image using the a and b values obtained in step S1;
in step S2, a specific method for performing the redness intensity estimation on the original image comprises:
S21: performing following calculations using the obtained a and b values:
$$weight A = \frac{abs ( a - 128 )}{127} ; \qquad \# ( 10 )$$
$$weight B = \frac{127 - abs ( b - 128 )}{127} ; \qquad \# ( 11 )$$
redness=(weightA*weightB)^{γ}# (12);
wherein abs( ) represents taking the absolute value, and y is a weight adjustment coefficient; and
S22: normalizing an obtained result to obtain an estimated redness intensity:
$$weight = \frac{redness}{max ( redness )} ; \qquad \# ( 13 )$$
wherein max( ) represents taking a maximum value;
S3: performing edge information extraction on the original image using the L value obtained in step S1;
in step S3, a specific method for performing the edge information extraction on the original image is: edge=L−L_{blur}#(14);
wherein L_{blur} represents a blurred image of an L channel;
S4: performing calibration on the original image by calculation using the L value, a redness intensity result and an edge information result obtained in step S1, step S2 and step S3, to obtain a calibration result L_{Q};
in step S4, a specific method for performing the calibration on the original image by calculation comprises:
S41: first, performing transformation on the L channel using a nonlinear mapping function as follows:
$$f ( L ) = \frac{{L}^{f} * {g}^{h}}{{g}^{h} * {L}^{f} + {( 1 - L )}^{h} * {e}^{f}} ; \qquad \# ( 15 )$$
wherein e, f, g, and h are adjustment parameters of the nonlinear mapping function to adjust an inflection point and a level of stretch of a mapping curve;
S42: adjusting an intensity of image calibration using following formula:
DeltaL=(f(L)−L)*coeffL+edge*coeffE# (16);
wherein coeffL=5, coeffE=4.5; and
S43: obtaining the calibration result L_{Q} using following formula, wherein L_{Q} ranges from 0 to 25;
L_{Q}=L+DeltaL*weight # (17); and
S5: converting the original image from the CIELAB color space to the RGB color space using the obtained L_{Q}, a, and b values, and outputting a resulting image.

2. The redness differentiation calibration (R.D.C.) method for medical images according to claim 1, wherein in step S1, the original image to be processed includes at least 8-bit images and 10-bit images in terms of color depth.

3. The redness differentiation calibration (R.D.C.) method for medical images according to claim 1, wherein the blurred image of the L channel is achieved by using a 9*9 Gaussian filter.

4. The redness differentiation calibration (R.D.C.) method for medical images according to claim 1, wherein e=5, f=1.7, g=8, and h=1.4.

5. The redness differentiation calibration (R.D.C.) method for medical images according to claim 4, wherein, in step S5, during converting, the X, Y, and Z values to be converted are first obtained through following formulas:
X=0.950456*xᵣ# (18);
Y=yᵣ# (19);
Z=1.088754*zᵣ# (20);
wherein
$${x}_{r} = \{ \begin{matrix}{f}_{x}^{3} , & for {f}_{x} > 0.008856 \\ ( 116 {f}_{x} - 16 ) / 903.3 , & for {f}_{x} \leq 0.008856\end{matrix} ; \qquad \# ( 21 )$$
$${z}_{r} = \{ \begin{matrix}{f}_{z}^{3} & for {f}_{z} > 0.008856 \\ ( 116 {f}_{z} - 16 ) / 903.3 , & for {f}_{z} \leq 0008 \; 856\end{matrix} ; \qquad \# ( 22 )$$
$${y}_{r} = \{ \begin{matrix}{( \frac{{L}_{Q} + 16}{116} )}^{3} , & for {L}_{Q} > 8 \\ \frac{116 {f}_{x} - 16}{903.3} , & for {L}_{Q} \leq 8\end{matrix} ; \qquad \# ( 23 )$$
$${f}_{x} = \frac{a}{500} + {f}_{y} ; \qquad \# ( 24 )$$
$${f}_{y} = \frac{{L}_{Q} + 16}{116} ; \qquad \# ( 25 )$$
